(19) United States
(12) Patent Application Publication
(10) Pub. No.: US 2024/0367004 A1
(43) Pub. Date: Nov. 7, 2024

(54) System and Method for Intelligent Physical Event Analysis and Providing Individualized Assessment

(71) Applicants: John Pilon, Dunrobin (CA); James Lindsay, Ottawa (CA)

(72) Inventors: John Pilon, Dunrobin (CA); James Lindsay, Ottawa (CA); Steve Wertheimer, Hudson (CA)

(73) Assignees: John Pilon, Dunrobin, ON (CA); James Lindsay, Ottawa, ON (CA)

(21) Appl. No.: 18/653,328

(22) Filed: May 2, 2024

Related U.S. Application Data
(60) Provisional application No. 63/463,362, filed on May 2, 2023.

(51) Int. Cl. A63B 24/00; A63B 71/06; G06N 3/092

(52) U.S. Cl. CPC A63B 24/0075; A63B 24/0062; A63B 71/0622; G06N 3/092; A63B 2024/0068; A63B 2024/0081; A63B 2220/806

(57) ABSTRACT

A system and method for intelligent physical event analysis and providing individualized assessment. The system includes three interconnected artificial intelligent (AI) systems that collectively enhance physical event understanding and user guidance. A first AI system receives data from environmental sensors and determines a nature of an event and assigns an event label. A second AI system is operably connected to the first AI system and detects a user action leading up to the event. The second AI system processes input data, in conjunction with the event label provided by the first AI system. The objective is to analyze the user actions and present suggestions for corrective measures, that are based on unique characteristics of the user. A third AI system utilizes the event data to predict anticipated outcomes. Once trained, the third AI system can operate independently to deliver personalized real-time analysis, advice, and coaching.

### CROSS REFERENCE TO RELATED APPLICATION

This application claims the benefit of pending U.S. Provisional Application No. 63/463,362 filed on May 2, 2023; the above identified patent application is herein incorporated by reference in its entirety.

### BACKGROUND OF THE INVENTION

The present invention relates to analysis and interaction systems. More specifically, the present invention relates to computer implemented real world physical training programs. The present invention provides an analysis system for sport related events, players participating in these events, the actions of the players when presented with incoming events and the providing guidance for improvement. Furthermore, the present invention provides a physical training system and method using Artificial Intelligence (AI), algorithms, statistical analysis and Bayesian logic to provide real-time feedback for a target individual presented as training and or coaching advice.

Computer-assisted sports training systems have become available due to the advancements in technology and the growing interest in sports and personal performance optimization. However, existing systems lack the ability to provide real-time feedback to individuals on their performance. While some existing systems are capable of collecting large amounts of data on an individual's movements and performance, the analysis and feedback process can be time-consuming, not always available in real-time, and generalized to populations and into individuals. Without immediate feedback, individuals and athletes may continue to make the same mistakes or have incorrect technique, which can negatively impact their performance and potentially lead to injury.

Another drawback is that the feedback provided by these systems may not be tailored to the specific needs of the individual. For example, a system may provide generic feedback on an athlete's running form without taking into account the athlete's individual strengths, weaknesses, and goals. This can limit the effectiveness of the feedback and potentially lead to incorrect adjustments to technique or training.

Furthermore, current systems may not be able to analyze the data collected in a meaningful way. The amount of data collected can be overwhelming, and without proper analysis, the data may not be useful for improving an individual's performance. This highlights the need for more sophisticated software and algorithms that can analyze the data, learn from the data, and provide actionable insights in real-time.

In summary, the inability of current computer-assisted physical training systems to provide real-time feedback to athletes, tailored to their specific needs, and the inability to analyze data in a meaningful way are significant drawbacks that limit their effectiveness. As technology continues to advance, it is essential that these issues are addressed to ensure that athletes can maximize the benefits of these systems and improve their performance.

In light of the devices disclosed in the known art, it is submitted that the present invention substantially diverges in design elements and methods from the known art and consequently it is clear that there is a need in the art for an improvement of a system and method for intelligent physical event analysis and providing individualized assessment. In this regard the instant invention substantially fulfills these needs.

### SUMMARY OF THE INVENTION

In view of the foregoing disadvantages inherent in the known types of systems and methods for physical training now present in the known art, the present invention provides a new system and method for physical training wherein the same can be utilized to provide real-time feedback for a target player presented as coaching advice, which includes both a full analysis and personalized guidance that is tailored to the individual. The system and method are configured to continuously update the AI systems for continued improvement in the real-time feedback provided.

It is an objective of the present invention to provide a system and method adapted to utilize the AI, statistics, and Bayes theorem for the purpose of interpreting and synthesizing information from multiple sources to deliver highly personalized coaching recommendations. The system employs AI models and algorithms configured to process and understand complex data from various sources, as well as providing users with intelligible and contextually relevant coaching and training insights. By leveraging the capabilities of Explainable AI (XAI), the system ensures that the training recommendations are both accurate and transparent, enabling users to comprehend the rationale behind each piece of guidance.

It is another objective of the present invention to provide a system configured to adapt and evolve over time, tailoring coaching recommendations to individual needs and preferences, thereby enhancing the overall effectiveness of personalized coaching across a wide array of domains.

It is another objective of the present invention to provide a system and method comprising AI, wherein the AI is associated with a target individual. The AI is configured to execute a training improvement method by receiving a video feed of a defined environment and physical feedback from sensors. The information is processed to predict a training improvement category from an action set. The predicted training improvement category is provided to the target player in real-time and presented as coaching/training advice.

It is another objective of the present invention to provide a system and method comprising AI and a Bayesian filter that is applied to the environmental feedback received from the system hardware and converted to a statistical measurement of a most probably error cause of the individual. The statistical measurement produced by the AI and Bayesian filter is analyzed by another AI algorithm, wherein the AI algorithm is configured to learn to provide better feedback to the AI-leading to better training improvement category predictions.

It is another objective of the present invention to provide a system wherein the AI performs a physical training improvement method comprising processing the environmental feedback from the system hardware and predicting a training improvement. The training improvement is provided to the individual in real-time and presented as coaching/training advice. The application in this embodiment is for employing the method for situations when feedback sources are untenable.

It is yet another objective of the present invention to provide a system comprising a cloud application comprising AI algorithms to assist individuals in learning or improving their skill set in a physical activity.

It is yet another objective of the present invention to provide an AI system configured to provide a flexible framework for analyzing complex relationships in data and quantifying uncertainty in predictions. In some embodiments, a Bayesian model is used to identify the most likely cause of a sports related mistake of a target player based on a statistical profile of the target player, as well as data from a physical device monitoring the environment. By incorporating prior knowledge and updating beliefs as new data is acquired, this Bayesian approach can effectively learn from the performance of the target player and provide personalized insights for improvement.

It is therefore an object of the present invention to provide a new and improved system and method for sports training that has all of the advantages of the known art and none of the disadvantages. Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of one embodiment of the system for intelligent physical event analysis and providing individualized assessment.

FIG. 2 shows a flow chart of an embodiment of the system and method for intelligent physical event analysis and providing individualized assessment.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for gathering, analyzing and providing feedback to an individual or target player. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment,” “second embodiment,” or “third embodiment” does not necessarily refer to the same embodiment.

As used herein “AI” includes but is not limited to the following technologies: neural networks, machine learning, deep learning; Bayes learning, deep reinforcement learning (DRL), supervised learning, physic inspired AI, explainable AI, generative AI, large language models, transformers, hybrid methods, ensemble methods, decision trees, and the like. As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry. References to “display” or “display screen” include any electronic device, such as a computer or tablet having an interactive touchscreen.

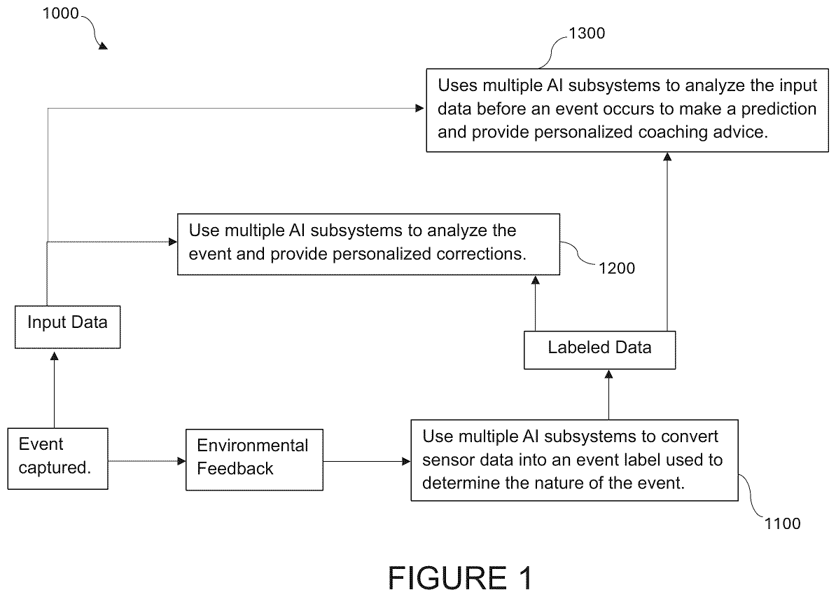

Referring now to FIG. 1, there is shown shows a block diagram of one embodiment of the system for intelligent physical event analysis and providing individualized assessment. In the illustrated embodiment, the system for intelligent physical event analysis and providing individualized assessment 1000 comprises includes three interconnected artificial intelligent (AI) systems that collectively enhance physical event understanding and user guidance. The system 1000 comprises a first AI system 1100 adapted to receive data from environmental sensors and determine a nature of an event and assigns an event label. A second AI system 1200 is operably connected to the first AI system 1100 and detects a user action leading up to the event. The second AI system 1200 processes input data, in conjunction with the event label provided by the first AI system 1100. A third AI system 1300 utilizes the event data to predict anticipated outcomes. Once fully trained, the third AI system 1300 is configured to operate independently, delivering personalized real-time analysis, advice, and coaching founded solely on input data. Each of the three AI systems are interlinked, but independent and each incorporate multiple AI algorithms. When an event requiring analysis or the generation of recommendations occurs, the system captures the event and categorizes all sources of information into two groups: environmental feedback or input data.

Environmental feedback includes various types of data sources, such as physical measurements (e.g., radar devices, accelerometers, etc.), sports capture devices (e.g., golf launch monitors, action cameras, etc.), GPS watches, basketball shot trackers, swimming lap counters, smart balls, drone cameras, sport sensors (sensor devices that can be attached to equipment or worn by athletes to capture data on aspects like swing speed, bat speed, or running and biking form), e-sports capture devices, punch trackers, smart tennis sensors, goaltender tracking systems, etc. Environmental feedback provides information used to determine what occurred.

Input data comprises data captured from individual data sources, including but not limited to video (e.g., cell phone cameras, high-speed cameras, action cameras, point-of-view cameras, smart helmets with built-in cameras, etc.), audio, wearable fitness trackers, smartwatch data, wearable biomechanical sensors, wearable technology, sports-specific wearable technology, sport sensors (sensor devices that can be attached to equipment or worn by athletes to capture data on aspects like swing speed, bat speed, or running and biking form), heart rate monitors, foot pods, etc.

In the illustrated embodiment, the first AI system 1100 receives and processes environmental feedback from one or more sensors by employing a variety of AI algorithms, including but not limited to physics-inspired AI, Bayesian learning, machine learning, and the like. This involves consolidating all the sensor data and discerning the events that transpired, subsequently assigning the relevant event label. The second AI system 1200 then processes the input data along with the event labels generated by the first AI system 1100 using one or more AI algorithms (which include but not limited to: all supervised learning algorithms; deep learning algorithms; all Deep Reinforcement Learning (DRL) algorithms; and all XAI algorithms). One objective of the second AI system 1200 is to analyze the user's actions leading to the event and provide suggestions for corrective actions. The AI systems are personalized for the user, wherein the user profile developed by the AI can be applied across various domains.

A third AI system 1300 leverages the event data to forecast expected outcomes, by selecting the appropriate event label based only on the input data. The third AI system 1300 then compares its prediction with the event label supplied by the first AI system 1100. Subsequently, each of the AI systems undergo updates to enhance their predictive accuracy. Once the third AI system is trained, it can operate autonomously, offering analysis, advice, and coaching based solely on input data.

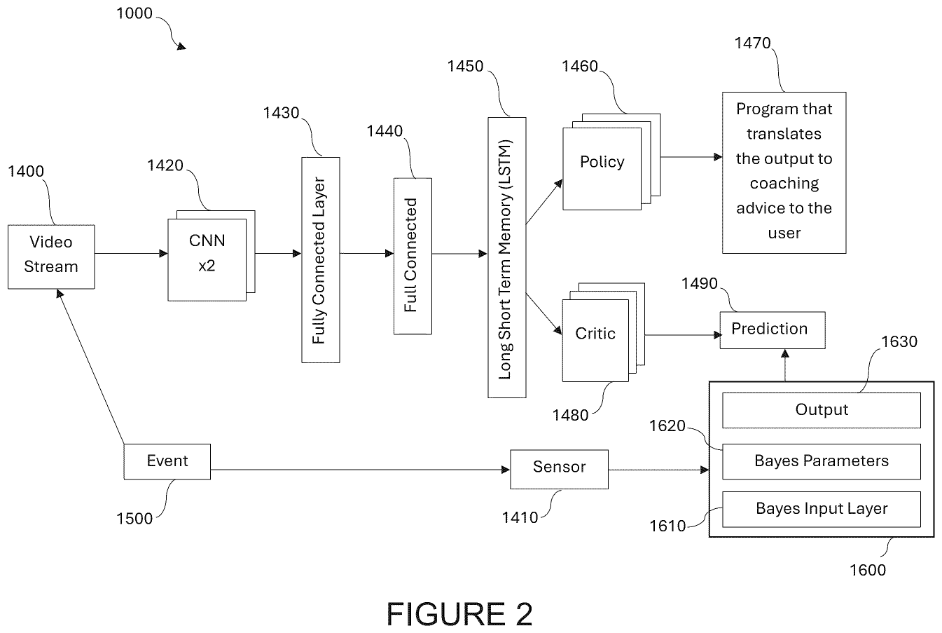

Referring to FIG. 2, there is shown a flow chart of an embodiment of the system and method for intelligent physical event analysis and providing individualized assessment. In the illustrated embodiment, the system 1000 comprises an electronic device having an AI system or neural network operably connected thereto and capable of transmitting and receiving data over a communication network. In some embodiments, the system comprises a cloud application accessible on any suitable electronic device. In one embodiment, the system and method comprise a combination of DRL, supervised learning, and Bayesian machine learning to assist a target player in learning or improving their skill level in a particular sport. In the illustrated embodiment, the neural network is associated with a target player. In this way, the target player can continuously receive improved and tailored feedback from the system 1000.

The system 1000 is configured to receive input from any suitable device capable of capturing an image or video feed 1400, such as a smart phone, or smart glasses. The system is also configured to receive input from cloud sources. The system 1000 is configured to operably connect to one or more hardware devices, such as sensors 1410, adapted to detect the physics of actions occurring during a sports game or a training event 1500. The video feed 1400 is operably connected to the neural network 1420 for receiving a defined environment and the hardware, such as a sensor, can be operably connected to the video feed or neural network to measure a physical feedback within the defined environment. The physical feedback and defined environment can comprise a plurality of different environmental objects such as players, sporting equipment, implemented boundaries, etc. As an example, the physical feedback and video feed provided to the system, wherein the system is directed to training a target player in the sport of golf, is configured to detect and analyze a swing, a grip, weight distribution, head and eye placement, ball rotation, hip, leg, and arm movement, ball and feet placement, and form of the target player.

The neural network 1420 further comprises an action set having a plurality of training improvement categories. The training improvement categories of the action set provide a complex list of improvements that can be selected by the system and provided to the target player upon a prediction that the target player needs improvement in a specific category as determined upon processing of the environmental feedback. In the illustrated embodiment, the system 1000 is configured to learn policy 1460 to make decisions and provide output 1470 in the manner of coaching. For example, the coaching output can be on course management, club selection, putting feedback and other strategies that are adapted to improve performance.

In the shown embodiment, the system 1000 further comprises a critic 1480 configured to evaluate the action set or output 1470. In some embodiments, the system comprises a Bayesian filter 1600 having a Bayesian logic, wherein the Bayesian filter 1600 is operably connected to the neural network 1420 and configured to receive physical feedback from the sensor 1410. The Bayesian filter 1600 comprises a bayes input layer 1610, one or more bayes parameters 1620, and an output 1630. The system 1000 is configured to apply a Bayesian Machine Learning filter to map feedback from the hardware devices to the action set that needs to be sent to the target player to improve performance in the identified training improvement category. In the illustrated example, the Bayesian logic is configured to perform a method of identifying one or more of the most likely causes of one or more playing errors of the target player. A statistical profile of the target player is created or received by the system. The system also receives the physical feedback from the hardware, wherein the relevant information is then extracted from the physical feedback. The relevant physical feedback and the statistical profile are then converted into a suitable format to be processed by the Bayesian filter 1600. The Bayesian filter 1600 can be trained by using the statistical profile and relevant physical feedback collected by updating the parameters 1620 of the Bayesian filter (such as prior probabilities or likelihood functions) to fit the statistical profile and relevant physical feedback. New data points are generated every time the neural network process is executed after a training event 1500 of the target player through the relevant physical feedback received by the system 1000. The Bayesian filter 1600 is then applied to convert the physical feedback to a statistical measurement to determine the most likely cause of the playing error of the target player. The determination results by calculating the posterior probabilities of each potential sport error cause given the observed data and selecting the playing error cause with the highest probability. The playing error cause is predicted 1490 by the Bayesian filter 1600 is then sent to be processed by the DRL algorithm. The system applies the DRL algorithm to analyze the data and provide real-time feedback to the target player on their performance, enabling them to improve their skills.

In some embodiments, the neural network is configured to execute an individualized assessment by receiving the video feed of the defined environment, wherein the target player is identifiable within the defined environment and receiving the physical feedback from the hardware. The video feed and the physical feedback are processed using multiple Convolutional layers. A training improvement category from the action set is predicted by the system and the video feed is sorted into the training improvement category via a fully connected layer 1430, a full connected layer 1440, and a long short term memory layer 1450. The training improvement category is provided to the target player in real-time and presented as coaching advice.

As the training improvement category is being predicted and provided to the target player, the Bayesian filter is applied to convert the physical feedback to a statistical measurement, wherein the statistical measurement produced by the Bayesian filter is then analyzed via the DRL algorithm, such that the DRL algorithm is configured to learn through trial and error to provide better feedback and make better decisions. The training improvement category predicted by the neural network is then compared to the statistical measurement (a sport error cause) generated by the Bayesian filter, wherein the neural network is updated based on the comparison results for an improved prediction to be subsequently provided.

In some embodiments, the system and method are adapted for supervised learning, which allows the system to be employed at sporting locations for one-time uses and by target players that do not want to save or build a profile on the system. In these embodiments, the system and method operate similarly to the DRL model mentioned above; however, there is no critic function, and the physical feedback is used to train a generalized model.

An objective of the system comprising the neural network is to select the right improvement or improvements, which is then provided to another program that presents the improvements as coaching advice to the target player. The system is configured to identify the current skill level of the target player and tailor the improvement feedback, accordingly, providing personalized coaching to help the target player progress. In some embodiments, the system is also configured to analyze data from previous training events to create personalized training programs that target specific areas for improvement. The system is configured to be used by target players as well as by coaches and instructors who can use the data generated by the application to develop customized training programs for their clients. The system can also provide generalized information and be used at driving ranges, golf courses, and indoor golf facilities. This application solves a fundamental problem that most golfers have in that it acts as an authoritative source for coaching, since it will not be subject to the biases of human instructors.

The system is configured to assist target players in creating muscle memory, promote self-tracking and benchmarking against other players based on age groups nationally/internationally. In some embodiments, the system comprises a smart sport eyewear having the neural network operably connected thereto, wherein the feedback can be provided on the eyewear to visually guide the player. Information can be received and displayed on the lenses in real time and process the information live on the field of play. As an example, a coach sends a play to a target player via a mobile electronic device, wherein the play is displayed in eyewear. The neural network operably connected to the eyewear analyzes the offense and defense positioning and determines if the play is suitable. If so, cadence is called, the ball is snapped, a virtual countdown clock starts and is displayed in the lenses. The quarterback throwing windows are displayed in real time over a playing surface. The window is configured to flash green or red based on receiver's position and defender's coverage. The lenses display a signal that defenders are approaching and provides the next logical steps. When a ball is thrown, the velocity of the ball can be calculated, as well as the release rate, position on field is displayed and number of drop back steps. All the information can be logged and tracked for progress. This application can be applied to receivers, running backs, defenders etc. as well as any type of sport such as baseball, hockey, tennis, soccer, driving etc.

In another example, the system 1000 is configured to analyze a golf swing to determine both an improvement area related with a shot and what corrections the individual can take to address the improvement area. In this embodiment, the system further comprises a golf launch monitor to label golf shot data and a radar device to label sports data, that can be used in the neural networks. Using physics inspired AI and/or Bayes Theorem and/or machine learning to translate any one of or more than one of the following physical measurements: club ID; ball speed; vertical launch angle; horizontal launch angle; club head speed; club path angle; backswing time; downswing time; attack angle; carry distance; total distance; apex height; carry deviation angle; carry deviation distance; total deviation angle; total deviation distance; target line angle; last modified time; club face angle; spin rate; spin axis; spin calculation type; ball type; temperature; humidity; target distance; air pressure” to both determining what is wrong with a golf swing and what are all the possible corrections that a golfer can take. The system then creates individualized deep neural networks that are designed for one user and the weights of the neural network are stored in a memory and loaded into the neural network every time the user logs in. The individualized neural networks and/or deep neural networks are adapted to be tailored to one individual but can be used across multiple domains or sports.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for intelligent physical event analysis and providing individualized assessment, comprising:
a source for capturing data of an event, wherein the data of the event is categorized as environmental feedback or input data;
a first artificial intelligence (AI) system configured to receive the environmental feedback from one or more sensors, wherein the first AI system incorporates multiple AI algorithms to consolidate sensor data and determine the event;
wherein an event label is assigned to each event by the first AI system;
a second AI system configured to process the input data in conjunction with the event labels provided by the first AI system;
wherein the second AI system is configured to analyze the input data leading to the event and provide a suggestion for a corrective action;
a third AI system configured to use captured data to predict expected outcomes by selecting the event labels based on the input data, and comparing a prediction with the suggestion for the corrective action, thereby facilitating iterative updates across the first and second AI systems to enhance predictive accuracy;
wherein once trained, the third AI system is configured to autonomously provide coaching advice based on input data.

2. The system of claim 1, wherein the multiple AI algorithms selected from the group consisting of physics-inspired AI, Bayesian learning, and machine learning.

3. The system of claim 1, wherein the environmental feedback includes data sources selected from the group consisting of radar devices, accelerometers, sports capture devices, GPS watches, basketball shot trackers, swimming lap counters, smart balls, drone cameras, and sport sensors.

4. The system of claim 1, wherein the input data comprises data captured from sources including, but not limited to, video feeds from cameras, audio data, wearable fitness trackers, smartwatch data, and wearable biomechanical sensors.

5. The system of claim 1, further comprising a cloud application configured to store, process, and manage data collected from the first, second and third AI systems, and to provide accessibility to the system across different devices and platforms.

6. The system of claim 1, wherein the first AI system is further configured to assign multiple event labels simultaneously depending on the complexity of the event data received from the environmental sensors.

7. The system of claim 1, wherein the second AI system is adapted to provide real-time coaching to a user based on an analysis of the actions of the user and the event data, wherein the real-time coaching is personalized to the user's specific characteristics and previous performance.

8. The system of claim 1, wherein the third AI system includes a predictive model that employs deep reinforcement learning algorithms to independently generate a prediction and coaching advice without requiring real-time data input from the first AI system.

9. The system of claim 1, further comprising the one or more sensors configured to detect a physical training environment.

10. The system of claim 1, wherein the system further includes user interfaces designed to display the analyzed data and suggested corrective actions in a user-friendly format.

11. The system of claim 1, further comprising:
an electronic device operably connected to the first, second and third AI system, the electronic device configured to transmit and receive the captured data over a communication network;
wherein the first, second and third AI system is associated with a target player;
a video feed operably connected to the first AI system, wherein the third AI system is adapted to predict the consequences of the actions of the target player;
a sensor operably connected to the video feed or the second AI system, the sensor configured to measure a physical feedback;
an action set comprising a plurality of training improvement categories;
a Bayesian filter comprising a Bayesian logic, wherein the Bayesian filter is operably connected to the third AI system and configured to receive the physical feedback from the sensor;
wherein the first, second and third AI system are configured to perform a sports training improvement method, the method comprising:
receiving the video feed, wherein the target player is identifiable within the video feed;
receiving the physical feedback from the sensor;
processing the video feed and the physical feedback using multiple convolutional layers;
predicting a training improvement category from the action set and sorting the video feed into the training improvement category via full connected layers and a long short term memory layer;
providing the training improvement category to the target player in real-time and presenting the training improvement category as the coaching advice;
applying the Bayesian filter to convert the physical feedback to a statistical measurement;
analyzing the statistical measurement produced by the Bayesian filter via a DRL algorithm, wherein the DRL algorithm is configured to learn through trial and error to provide better feedback and make better decisions;
comparing the training improvement category predicted by the neural network to the statistical measurement generated by the Bayesian filter;
updating a weight of the first, second and third AI system.

12. The system of claim 11, wherein the Bayesian logic is configured to perform a method of identifying the playing error cause of the target player, the method of identifying the playing error cause comprising the following steps:
creating or receiving a statistical profile of the target player;
receiving the physical feedback from the sensor;
extracting relevant information from the physical feedback;
converting the relevant physical feedback and the statistical profile into a suitable format to be processed by the Bayesian filter;
training the Bayesian filter using the statistical profile and relevant physical feedback collected via updating the parameters of the Bayesian filter to fit the statistical profile and relevant physical feedback;
generating a new data point via the relevant physical feedback;
applying the Bayesian filter to convert the physical feedback to a measurement and determine the most likely cause of the playing error of the target player via calculating the posterior probabilities of each potential sport error cause given the observed data and selecting the playing error cause with the highest probability;
sending the playing error cause predicted by the Bayesian filter to be processed by the DRL algorithm.

13. The system of claim 11, wherein the image feed is a camera.

14. The system and method of claim 11, further comprising receiving a pre-existing video.

15. The system of claim 14, further comprising assessing and assigning a skill level to the target player.

16. The system of claim 15, further comprising storing the skill level of the target player.

17. The system of claim 1, further comprising:
an electronic device operably connected first, second and third AI system and capable of transmitting and receiving the captured data over a communication network;
wherein the first, second and third AI system are associated with a target player;
a video feed operably connected to the first AI system, wherein the third AI system is adapted to predict the consequences of the actions of the target player;
a sensor operably connected to the video feed the second AI system configured to measure a physical feedback;
an action set comprising a plurality of training improvement categories;
wherein the neural network is configured to perform a sports training improvement method, the method comprising:
receiving the video feed, wherein the target player is identifiable within the video feed;
receiving the physical feedback from the sensor;
processing the video feed and the physical feedback using multiple convolutional layers;
predicting a training improvement category from the action set and sorting the video feed into the training improvement category via full connected layers and a long short term memory layer;
providing the training improvement category to the target player in real-time and presenting the training improvement category as the coaching advice.
